(19) United States
(12) Patent Application Publication
(10) Pub. No.: US 2023/0206603 A1
(43) Pub. Date: Jun. 29, 2023

(54) HIGH-PRECISION POINT CLOUD COMPLETION METHOD BASED ON DEEP LEARNING AND DEVICE THEREOF

(71) Applicant: NANJING UNIVERSITY OF POSTS AND TELECOMMUNICATIONS, Nanjing (CN)

(72) Inventors: Dengyin ZHANG, Nanjing (CN); Yingying FENG, Nanjing (CN); Li HUANG, Nanjing (CN); Weidan YAN, Nanjing (CN)

(73) Assignee: NANJING UNIVERSITY OF POSTS AND TELECOMMUNICATIONS, Nanjing (CN)

(21) Appl. No.: 18/094,867

(22) Filed: Jan. 9, 2023

Related U.S. Application Data
(63) Continuation of application No. PCT/CN2022/133946, filed on Nov. 24, 2022.

(30) Foreign Application Priority Data
Sep. 19, 2022 (CN) 202211135259.8

(51) Int. Cl. G06V 10/77; G06V 10/80; G06V 10/82; G06V 10/44

(52) U.S. Cl. CPC G06V 10/7715; G06V 10/80; G06V 10/82; G06V 10/44

(57) ABSTRACT

The present disclosure discloses a high-precision point cloud completion method based on deep learning and a device thereof, which comprises the following steps: introducing dynamic kernel convolution PAConv into a feature extraction module, learning a weight coefficient according to the positional relationship between each point and its neighboring points, and adaptively constructing the convolution kernel in combination with the weight matrix. A spatial attention mechanism is added to a feature fusion module, which facilitates a decoder to better learn the relationship among various features, and thus better represent the feature information. A discriminator module comprises global and local attention discriminator modules, which use multi-layer full connection to classify and determine whether the generated results conform to the real point cloud distribution globally and locally, respectively, so as to optimize the generated results.

### CROSS-REFERENCE TO RELATED APPLICATIONS

The application claims priority to Chinese patent application No. 202211135259.8, filed on Sep. 19, 2022, the entire contents of which are incorporated herein by reference.

### TECHNICAL FIELD

The present disclosure relates to the technical field of computer three-dimensional point cloud completion and deep learning, in particular to a high-precision point cloud completion method based on deep learning and a device thereof.

### BACKGROUND

In 3D computer vision application, the original point clouds captured by 3D scanners and depth cameras are usually sparse and incomplete due to occlusion and limited sensor resolution. The defect in the shape of a point cloud model greatly limits the perception ability of vision and AI. Point cloud completion is to complete an incomplete point cloud through an algorithm model, which is a basic technology in the field of 3D vision, and at the same time, which is also a necessary step of acquiring the complete point cloud model of 3D objects and is the basis of subsequent related work.

The existing point cloud completion methods based on deep learning can infer a relatively complete and reasonable point cloud model, but they often have defects in completing local detail features.

Therefore, making up for the defects of the point cloud completion methods based on deep learning in local feature extraction will be beneficial to characterizing the complex changing relationship of point cloud space so as to improve the precision of point cloud completion.

### SUMMARY

In order to solve the shortcomings in the prior art and the problem of insufficient local feature extraction in the current point cloud completion methods, the present disclosure provides a high-precision point cloud completion method based on deep learning, comprising: introducing dynamic kernel convolution PAConv into a feature extraction module, learning a weight coefficient according to the positional relationship between each point and its neighboring points, and adaptively constructing the convolution kernel in combination with the weight matrix. A spatial attention mechanism is added to a feature fusion module, which facilitates a decoder to better lean the relationship among various features, and thus better represent the feature information. A discriminator module comprises global and local attention discriminator modules, which use multi-layer full connection to classify and determine whether the generated results conform to the real point cloud distribution globally and locally, respectively, so as to optimize the generated results. Therefore, the precision of point cloud completion is improved, and a complete and precise point cloud completion result is obtained, which also guarantees the smooth progress of many downstream tasks such as point cloud segmentation, classification, object recognition and point cloud reconstruction.

Technical scheme: in order to solve the above technical problems, the technical scheme used by the present disclosure is as follows.

In a first aspect, a high-precision point cloud completion method based on deep learning is provided, comprising:

acquiring point cloud data to be processed;

preprocessing the point cloud data to obtain preprocessed point cloud data;

inputting the preprocessed point cloud data into a trained point cloud completion model, wherein the point cloud completion model comprises a multi-resolution encoder module, a pyramid decoder module and an attention discriminator module;

the multi-resolution encoder module is configured to perform feature extraction and fusion on the input point cloud data to obtain feature vectors;

the pyramid decoder module is configured to process the feature vectors to obtain point cloud completion results of three scales;

the attention discriminator module is configured to use the idea of a generative adversarial network to produce the results of consistency of global and local features through mutual game learning between a generation model and a discrimination model;

determining high-precision point cloud completion results according to the output of the point cloud completion model.

In some embodiments, the multi-resolution encoder module comprises a feature extraction module and a feature fusion module.

a dynamic convolution layer PAConv is embedded in a multi-layer perceptron with shared weights in the feature extraction module, a weight coefficient is learned according to the positional relationship between each point and its neighboring points, and the convolution kernel is adaptively constructed in combination with the weight matrix, so as to improve the capability of extracting local detail features;

a spatial attention mechanism is added to the feature fusion module to realize feature focusing in spatial dimension;

three missing point clouds of different scales generated by sampling the farthest point are input into the multi-resolution encoder module:

the feature extraction module of the multi-layer perceptron embedded in the dynamic kernel convolution PAConv is used to extract the features of three missing point clouds of different scales to generate multidimensional feature vectors V₁, V₂, V₃; the output multidimensional feature vectors V₁, V₂, V₃ are input into the feature fusion module consisted of the spatial attention mechanism, the spatial attention mechanism learns 1024-dimensional abstract features that synthesize local features and global information, and outputs weighted features of each position; thereafter, three 1024-dimensional abstract features are spliced by a splicing array, and finally, the potential feature mapping is integrated into the final feature vector V with 1024 dimensions using the MLP.

Further, the method of constructing the dynamic kernel convolution PAConv comprises:

initializing a weight library W={Wₖ|k=1, 2, . . . , K} consisted of K weight matrices with the size of Cᵢₙ× Cₒᵤₜ, wherein Cᵢₙ represents the input dimension of the network in the current layer and Cₒᵤₜ represents the output dimension of the network in the current layer;

calculating the relative position relationship between each point pᵢ in the input point cloud and the neighboring points pⱼ, and learning the weight coefficients Eᵢⱼ={Eₖ_{ᵢⱼ}|k=1, 2, . . . , K} at different positions, which are expressed as:

Eᵢⱼ=Softmax(θ(pᵢ,pⱼ))

where θ is a nonlinear function implemented by the convolution with a kernel size of 1×1; using the softmax function for normalization operation to ensure that the output score is in the range (0,1), in which a higher score means that the corresponding position has more important local information;

forming the kernel of PAConv by combining the weight matrix Wₖ and the weight coefficient Eₖ_{ᵢⱼ} learned from the point position,

[symbol]

(pᵢ,pⱼ)=Σₖ^{K}Eₖ_{ᵢⱼ}Wₖ

completing the work of constructing the convolution kernel adaptively by the dynamic kernel convolution PAConv so far, so as to capture the local area information of the input features and output the features with local correlation.

Preferably, the value of K is 16.

In some embodiments, processing the feature vectors to obtain point cloud completion results of three scales comprises: obtaining three sub-feature vectors U₁, U₂, U₃ with different resolutions by the feature vectors V through the full connection layer, wherein each sub-feature vector is responsible for completing the point clouds with different resolutions; using U₃ to predict a primary point cloud P₃, using U₂ to predict the relative coordinate of a secondary point cloud P₂ from the central point P₃, and using the recombination and full connection operation to generate the secondary point cloud P₂ according to P₃; and using U₁ and P₂ to predict the relative coordinate of the final point cloud P₁ from the center point P₂ to supplement the final point cloud P₁.

In some embodiments, the attention discriminator module comprises a global attention discriminator and a local attention discriminator; the global discriminator is configured to view the whole point cloud completion result to evaluate its overall consistency, and the local discriminator module views a small area centered on the completed area to ensure the local consistency of the generated point cloud.

In some embodiments, the processing process of the attention discriminator module comprises: sending the whole or local generated point cloud and the real point cloud to the attention discriminator, obtaining the feature vector with 512 dimensions through an auto-encoder therein, and then reducing the dimension [512-256-128-16-1] through the continuous full connection layer, and outputting the final fake or real binary result.

In some embodiments, the training method of the point cloud completion model comprises:

a loss function comprising two parts: a generated loss and an adversarial loss;

using a chamfer distance CD to calculate the average shortest point distance between the generated point cloud and the real point cloud on the ground, in which the calculation formula is as follows:

$${d}_{CD} ( {S}_{1} , {S}_{2} ) = {d}_{CD} ( {S}_{1} \to {S}_{2} ) + {d}_{CD} ( {S}_{2} \to {S}_{1} ) =$$

$$\frac{1}{{S}_{1}} {\sum }_{x ∈ {S}_{1}} {min}_{y ∈ {S}_{2}} {‖ x - y ‖}_{2}^{2} + \frac{1}{{S}_{2}} {\sum }_{x ∈ {S}_{2}} {min}_{y ∈ {S}_{1}} {‖ y - x ‖}_{2}^{2}$$

where x and y represent a point in the generated point cloud or the real point cloud; P*P represents the distance: CD calculates the average nearest square distance between the generated point cloud S₁ and the real point cloud S₂, the final generated results are three generated point clouds P₁, P₂, P₃ of different scales, and the generated loss also consists of three parts, that is, d_{CD}_{₁}, d_{CD}_{₂}, d_{CD3}, which correspond to the CD values of the three generated point clouds of different scales, respectively, in which α represents the sum weight in the generated loss;

the generated loss L_{com} has the following expression:

L_{com}=d_{CD}_{₁}(P₁,P_{1gt})+αd_{CD}_{₂}(P₂,P_{2gt})+2αd_{CD}_{₃}(P₃,P_{3gt})

where P_{1gt}, P_{2gt}, P_{3gt} are the real point clouds corresponding to the three generated point clouds of different scales, respectively;

the adversarial loss refers to the adversarial network GAN, and the adversarial loss L_{adv} is as follows:

L_{adv}=Σ_{1≤i≤S} log₁₀(G(yᵢ))+Σ_{1≤j≤S} log₁₀(1−G(E(D(xᵢ))))

where yᵢ and xᵢ belong to an original incomplete point cloud and a real point cloud, respectively, S represents the data set size; E, D, G represent the multi-resolution encoder, the pyramid decoder and the attention discriminator, respectively;

the total loss function L consists of the generated loss and the adversarial loss:

L=βL_{com}+λL_{adv}

β and λ are the weights of the generated loss L_{com} and the adversarial loss L_{adv}, respectively, satisfying the following condition: β+λ=1; the chamfer distance CD is also used as an evaluation index to test the completion performance.

In a second aspect, the present disclosure provides a high-precision point cloud completion device based on deep learning, comprising a processor and a storage medium;

wherein the storage medium is configured to store instructions;

the processor is configured to operate according to the instructions to perform the steps of the method according to the first aspect.

In a third aspect, the present disclosure provides a storage medium on which a computer program is stored, wherein the computer program, when executed by a processor, implements the steps of the method according to the first aspect.

The advantages of the present disclosure: compared with the prior art, the method provided by the present disclosure has the following technical effects: (1) the present disclosure introduces dynamic kernel convolution PAConv into a feature extraction module, learns a weight coefficient according to the positional relationship between each point and its neighboring points, and adaptively constructs the convolution kernel in combination with the weight matrix, so that the information of local areas can be flexibly captured.

(2) The present disclosure adds a spatial attention mechanism to a feature fusion module, so that the decoder better learns the relationship among various features and improves the precision of point cloud completion.

(3) The present disclosure comprises global and local attention discriminator modules in the discriminator module, which use multi-layer full connection to classify and determine whether the generated results conform to the real point cloud distribution globally and locally, respectively, so as to optimize the generated results.

The present disclosure has the advantages of making up for the defects of the point cloud completion method based on deep learning in local feature extraction. The PAConv layer and the spatial attention mechanism are introduced, so as to improve the precision of point cloud completion and obtain a more complete and precise point cloud completion result; global and local attention discriminator modules are introduced to ensure the global and local consistency between the generated point cloud and the real point cloud. At the same time, point cloud completion also guarantees the smooth progress of many downstream tasks such as point cloud segmentation, classification, object recognition and point cloud reconstruction.

### BRIEF DESCRIPTION OF DRAWINGS

FIG. 1 is a schematic diagram of the overall network framework according to an embodiment of the present disclosure.

FIG. 2 is a schematic diagram of a spatial attention mechanism according to an embodiment of the present disclosure.

FIG. 3 is a schematic diagram of a PAConv structure according to an embodiment of the present disclosure.

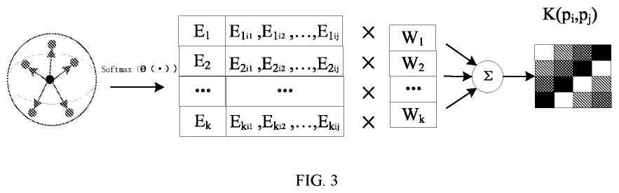

FIG. 4 is a schematic diagram of a missing point cloud completion process according to an embodiment of the present disclosure.

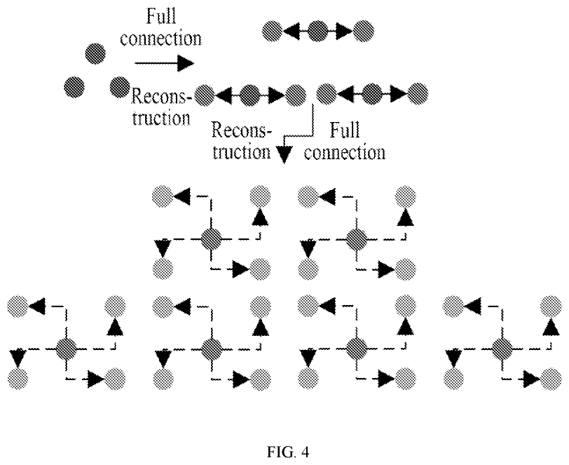

### DETAILED DESCRIPTION OF THE EMBODIMENTS

In order to make the technical means, creative features, objectives and effects of the present disclosure understandable, the present disclosure will be further illustrated with reference to specific embodiments.

In the description of the present disclosure. “several” meanings more than one, “a plurality of” meanings more than two, “greater than, less than, more than, etc.” are understood as excluding the number itself, and “above, below, within, etc.” are understood as including the number itself. If a first and a second are described, they are only used for the purpose of distinguishing technical features, but cannot be understood as indicating or implying relative importance, or implicitly indicating the number of indicated technical features or implicitly indicating the sequence of indicated technical features.

In the description of the present disclosure, the description referring to the terms “one embodiment”. “some embodiments”, “illustrative embodiments”. “examples”. “specific examples” or “some examples” means that the specific features, structures, materials or characteristics described in connection with the embodiment or example are included in at least one embodiment or example of the present disclosure. In this specification, the schematic expressions of the above terms do not necessarily refer to the same embodiment or example. Furthermore, the specific features, structures, materials or characteristics which are described may be combined in any one or more embodiments or examples in a suitable manner.

### Embodiment 1

A high-precision point cloud completion method based on deep learning comprises:

acquiring point cloud data to be processed;

preprocessing the point cloud data to obtain preprocessed point cloud data;

inputting the preprocessed point cloud data into a trained point cloud completion model, wherein the point cloud completion model comprises a multi-resolution encoder module, a pyramid decoder module and an attention discriminator module;

the multi-resolution encoder module is configured to perform feature extraction and fusion on the input point cloud data to obtain feature vectors;

the pyramid decoder module is configured to process the feature vectors to obtain point cloud completion results of three scales;

the attention discriminator module is configured to use the idea of a generative adversarial network to produce the results of consistency of global and local features through mutual game learning between a generation model and a discrimination model;

determining high-precision point cloud completion results according to the output of the point cloud completion model.

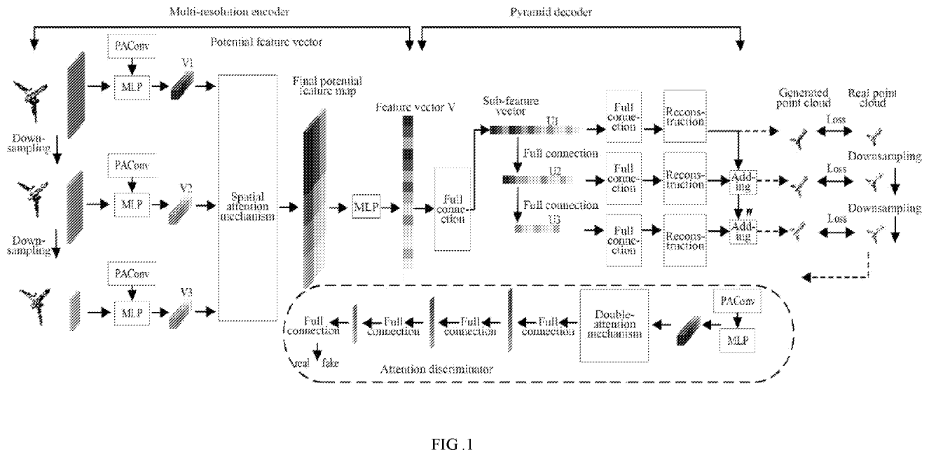

In some embodiments, a high-precision point cloud completion method based on deep learning is provided. As shown in FIG. 1, the overall framework of the point cloud completion method comprises three parts: a multi-resolution encoder, a pyramid decoder and an attention discriminator. The multi-resolution encoder module extracts the features of the input point cloud; the pyramid decoder processes the fused feature vectors to obtain point cloud completion results of three scales; the attention discriminator calculates the adversarial loss, and generates good output through mutual game learning, which ensures the overall and local consistency between the generated point cloud and the real point cloud. The implementation methods and functions of each module are described in detail hereinafter.

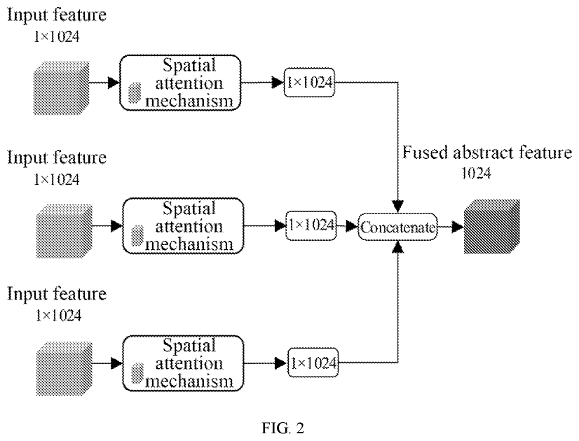

First, the farthest point from the existing set of sampling points is selected iteratively by sampling the farthest point, so as to acquire a set of skeleton points. This can represent the distribution of point sets more evenly, without destroying the structure of a point cloud model. Three missing point clouds of different scales generated by sampling the farthest point are input into the multi-resolution encoder module to extract feature. The multi-layer perceptron embedded in the dynamic kernel convolution PAConv is used to generate multidimensional feature vectors V₁, V₂, V₃. The output multidimensional feature vectors V₁, V₂, V₃ are input into the feature fusion module consisted of the spatial attention mechanism, the structure of which is shown in FIG. 2. The spatial attention mechanism learns 1024-dimensional abstract features that synthesize local features and global information, realizes feature focus in spatial dimension, and outputs weighted features of each position. Thereafter, three 1024-dimensional abstract features are spliced by a splicing array, and finally, the potential feature mapping is integrated into the final feature vector V with 1024 dimensions using the MLP.

PAConv first initializes a weight library W={Wₖ|k=1, 2, . . . , K} consisted of K weight matrices with the size of Cᵢₙ×Cₒᵤₜ wherein Cᵢₙ represents the input dimension of the network in the current layer and Cₒᵤₜ represents the output dimension of the network in the current layer. The larger K can ensure the diversity of the convolution kernel, which will also increase the burden of the model. Therefore, in our network model, the value K will be taken as 16. Next, the relative position relationship between each point pᵢ in the input point cloud and the neighboring points pⱼ is calculated, and the weight coefficients Eᵢⱼ={Eₖ_{ᵢⱼ}|k=1, 2, . . . , K} at different positions are learned. This process can be expressed as:

Eᵢⱼ=Softmax(θ(pᵢ,pⱼ) (1)

where θ is a nonlinear function implemented by the convolution with a kernel size of 1×1. The softmax is used for normalization operation to ensure that the output score is in the range (0,1), in which a higher score means that the corresponding position has more important local information. The kernel of PAConv is formed by combining the weight matrix Wₖ and the weight coefficient Eₖ_{ᵢⱼ} learned from the point position,

[symbol]

(pᵢ,pⱼ)=Σₖ^{K}Eₖ_{ᵢⱼ}Wₖ (2)

PAConv completes the work of constructing the convolution kernel adaptively so far, so as to capture the local area information of the input features and output the features with local correlation.

The pyramid decoder module consists of a full connection layer and a recombination layer. Using the idea of the feature pyramid network, the missing point cloud is gradually completed from coarsely to finely. The input is the output feature vector V of a multi-resolution encoder. Three sub-feature vectors U₁, U₂, U₃ with different resolutions are obtained through the full connection layer, and the dimensions are 1024, 512, 256. Each sub-feature vector is responsible for completing the point clouds with different resolutions. First. U₃ is used to predict a primary point cloud P₃, U_{z} is used to predict the relative coordinate of a secondary point cloud P₂ from the central point P₃, and the recombination and full connection operation is used to generate the secondary point cloud P_{Z} according to P₃. Similarly, U₁ and P₂ are used to predict the relative coordinate of the final point cloud P₁ from the center point P_{Z} to supplement the final point cloud P₁.

The attention discriminator module uses the idea of a generative adversarial network to generate good output through mutual game learning between the generation model and a discrimination model in the framework. The module consists of a global attention discriminator and a local attention discriminator. The global discriminator views the whole point cloud completion result to evaluate its overall consistency, and the local discriminator module views a small area centered on the completed area to ensure the local consistency of the generated point cloud. Specifically, the whole or local generated point cloud and the real point cloud are sent to the attention discriminator, the feature vector with 512 dimensions is obtained through an auto-encoder therein, and then the dimension [512-256-129-16-1] is reduced through the continuous full connection layer, and the final fake or real binary result is output.

The loss function of the algorithm of the present disclosure comprises two parts: a generated loss and an adversarial loss.

A chamfer distance CD is used to calculate the average shortest point distance between the generated point cloud and the real point cloud on the ground, in which the calculation formula is as follows:

$${d}_{CD} ( {S}_{1} , {S}_{2} ) = {d}_{CD} ( {S}_{1} \to {S}_{2} ) + {d}_{CD} ( {S}_{2} \to {S}_{1} ) = \qquad ( 3 )$$

$$\frac{1}{{S}_{1}} {\sum }_{x ∈ {S}_{1}} {min}_{y ∈ {S}_{2}} {‖ x - y ‖}_{2}^{2} + \frac{1}{{S}_{2}} {\sum }_{x ∈ {S}_{2}} {min}_{y ∈ {S}_{1}} {‖ y - x ‖}_{2}^{2}$$

In formula (3), CD calculates the average nearest square distance between the generated point cloud S₁ and the real point cloud S₂, the final generated results are three generated point clouds P₁, P₂, P₃ of different scales, and the total loss also consists of three parts, that is, d_{CD}_{₁}, d_{CD}_{₂}, d_{CD3}, which correspond to the CD values of the three generated point clouds of different scales, respectively, in which α represents the sum weight in the generated loss. The total loss expression is:

L_{com}=d_{CD}_{₁}(P₁,P_{1gt})+αd_{CD}_{₂}(P₂,P_{2gt})+2αd_{CD}_{₃}(P₃,P_{3gt}) (4)

In formula (4), P_{1gt}, P_{2gt}, P_{3gt} are the real point clouds corresponding to the three generated point clouds of different scales, respectively. The adversarial loss herein refers to the adversarial network GAN, and the calculation formula is as follows:

L_{adv}=Σ_{1≤i≤S} log₁₀(G(yᵢ))+Σ_{1≤j≤S} log₁₀(1−G(E(D(xᵢ)))) (5)

In formula (5), where yᵢ and xᵢ belong to an original incomplete point cloud and a real point cloud, respectively. E, D, G represent the multi-resolution encoder, the pyramid decoder and the attention discriminator, respectively. The total loss function consists of the generated loss and the adversarial loss. The calculation formula is shown in Formula (6):

L=βL_{com}+ΔL_{adv} (6)

β and λ are the weights of the generated loss L_{com} and the adversarial loss L_{adv}, respectively, satisfying the following condition: β+λ=1; the chamfer distance CD is also used as an evaluation index to test the completion performance.

The system provided by the present disclosure has the following advantages.
(1) In order to make up for the defect of the point cloud completion method based on deep learning in local feature extraction, a feasible scheme is proposed.
(2) A point cloud model with high completion precision can be obtained, which guarantees the smooth progress of many downstream tasks such as point cloud segmentation, classification, object recognition and point cloud reconstruction.

The point cloud completion method based on deep learning according to the present disclosure can extract the global and local features of the point cloud and synthesize the local correlation and global information of key points, which makes up for the defect of the point cloud completion method based on deep learning in local feature extraction, improves the precision of point cloud completion, and guarantees the smooth progress of many downstream tasks such as point cloud segmentation, classification, object recognition and point cloud reconstruction.

### Embodiment 2

In a second aspect, this embodiment provides a high-precision point cloud completion device based on deep learning, comprising a processor and a storage medium;

wherein the storage medium is configured to store instructions;

the processor is configured to operate according to the instructions to perform the steps of the method according to Embodiment 1.

### Embodiment 3

In a third aspect, this embodiment provides a storage medium on which a computer program is stored, wherein the computer program, when executed by a processor, implements the steps of the method according to Embodiment 1.

It should be understood by those skilled in the art that the embodiments of the present disclosure can be provided as methods, systems, or computer program products. Therefore, the present disclosure can take the form of an entirely hardware embodiment, an entirely software embodiment, or an embodiment combining software and hardware. Furthermore, the present disclosure may take the form of a computer program product implemented on one or more computer-available storage media (including but not limited to a disk storage, CD-ROM, an optical storage, etc.) in which computer-available program codes are contained.

The present disclosure is described with reference to flowcharts and/or block diagrams of methods, devices (systems), and computer program products according to the embodiments of the present disclosure. It should be understood that each flow and/or block in flowcharts and/or block diagrams and combinations of flows and/or blocks in flowcharts and/or block diagrams can be implemented by computer program instructions. These computer program instructions may be provided to the processor of a general-purpose computer, a special-purpose computer, an embedded processor or other programmable data processing devices to produce a machine, so that the instructions executed by the processor of the computer or other programmable data processing devices produce a device for implementing the functions specified in one or more flows in flowcharts and/or one or more blocks in block diagrams.

These computer program instructions can also be stored in a computer-readable memory that can direct a computer or other programmable data processing devices to work in a specific way, so that the instructions stored in the computer-readable memory produce an article of manufacture including an instruction device that implement the functions specified in one or more flows in flowcharts and/or one or more blocks in block diagrams.

These computer program instructions can also be loaded on a computer or other programmable data processing devices, so that a series of operation steps are executed on the computer or other programmable devices to produce a computer-implemented process, so that the instructions executed on the computer or other programmable devices provide steps for implementing the functions specified in one or more flows in flowcharts and/or one or more blocks in block diagrams.

According to the technical knowledge, the present disclosure can be implemented by other embodiments without departing from the spirit or essential characteristics thereof. Therefore, the embodiments disclosed above are just examples in all respects, rather than the only embodiments. All changes within the scope of the present disclosure or within the scope equivalent to the present disclosure are included within the present disclosure.

What is claimed is:

1. A high-precision point cloud completion method based on deep learning, comprising:
acquiring point cloud data to be processed;
preprocessing the point cloud data to obtain preprocessed point cloud data;
inputting the preprocessed point cloud data into a trained point cloud completion model, wherein the point cloud completion model comprises a multi-resolution encoder module, a pyramid decoder module and an attention discriminator module;
the multi-resolution encoder module is configured to perform feature extraction and fusion on the input point cloud data to obtain feature vectors;
the pyramid decoder module is configured to process the feature vectors to obtain point cloud completion results of three scales;
the attention discriminator module is configured to use the idea of a generative adversarial network to produce the results of consistency of global and local features through mutual game learning between a generation model and a discrimination model;
determining high-precision point cloud completion results according to the output of the point cloud completion model.

2. The high-precision point cloud completion method based on deep learning according to claim 1, wherein the multi-resolution encoder module comprises a feature extraction module and a feature fusion module,
a dynamic convolution layer PAConv is embedded in a multi-layer perceptron with shared weights in the feature extraction module, a weight coefficient is learned according to the positional relationship between each point and its neighboring points, and the convolution kernel is adaptively constructed in combination with the weight matrix, so as to improve the capability of extracting local detail features;
a spatial attention mechanism is added to the feature fusion module to realize feature focusing in spatial dimension;
three missing point clouds of different scales generated by sampling the farthest point are input into the multi-resolution encoder module;
the feature extraction module of the multi-layer perceptron embedded in the dynamic kernel convolution PAConv is used to extract the features of three missing point clouds of different scales to generate multidimensional feature vectors V₁, V₂, V₃; the output multidimensional feature vectors V₁, V₂, V₃ are input into the feature fusion module consisted of the spatial attention mechanism, the spatial attention mechanism learns 1024-dimensional abstract features that synthesize local features and global information, and outputs weighted features of each position; thereafter, three 1024-dimensional abstract features are spliced by a splicing array, and finally, the potential feature mapping is integrated into the final feature vector V with 1024 dimensions using the MLP.

3. The high-precision point cloud completion method based on deep learning according to claim 2, wherein the method of constructing the dynamic kernel convolution PAConv comprises:
initializing a weight library W={Wₖ|k=1, 2, . . . , K} consisted of K weight matrices with the size of Cᵢₙ×Cₒᵤₜ, wherein Cᵢₙ represents the input dimension of the network in the current layer and Cₒᵤₜ represents the output dimension of the network in the current layer;
calculating the relative position relationship between each point pᵢ in the input point cloud and the neighboring points pⱼ, and learning the weight coefficients Eᵢⱼ={Eₖ_{ᵢⱼ}|k=1, 2, . . . , K} at different positions, which are expressed as:
Eᵢⱼ=Softmax(θ(pᵢ,pⱼ))
where θ is a nonlinear function implemented by the convolution with a kernel size of 1×1; using the Softmax function for normalization operation to ensure that the output score is in the range (0,1), in which a higher score means that the corresponding position has more important local information;
forming the kernel of PAConv by combining the weight matrix Wₖ and the weight coefficient Eₖ_{ᵢⱼ} learned from the point position,
$$𝒦 ( {p}_{i} , {p}_{j} ) = {\sum }_{k}^{K} {E}_{{k}_{ij}} {W}_{k}$$
completing the work of constructing the convolution kernel adaptively by the dynamic kernel convolution PAConv so far, so as to capture the local area information of the input features and output the features with local correlation.

4. The high-precision point cloud completion method based on deep learning according to claim 3, wherein the value of K is 16.

5. The high-precision point cloud completion method based on deep learning according to claim 1, wherein processing the feature vectors to obtain point cloud completion results of three scales comprises: obtaining three sub-feature vectors U₁, U₂, U₃ with different resolutions by the feature vectors V through the full connection layer, wherein each sub-feature vector is responsible for completing the point clouds with different resolutions; using U₃ to predict a primary point cloud P₃, using U₂ to predict the relative coordinate of a secondary point cloud P₂ from the central point P₃, and using the recombination and full connection operation to generate the secondary point cloud P₂ according to P₃; and using U₁ and P₂ to predict the relative coordinate of the final point cloud P₁ from the center point P₂ to supplement the final point cloud P₁.

6. The high-precision point cloud completion method based on deep learning according to claim 1, wherein the attention discriminator module comprises a global attention discriminator and a local attention discriminator; the global discriminator is configured to view the whole point cloud completion result to evaluate its overall consistency, and the local discriminator module views a small area centered on the completed area to ensure the local consistency of the generated point cloud.

7. The high-precision point cloud completion method based on deep learning according to claim 6, wherein the processing process of the attention discriminator module comprises: sending the whole or local generated point cloud and the real point cloud to the attention discriminator, obtaining the feature vector with 512 dimensions through an auto-encoder therein, and then reducing the dimension [512-256-128-16-1] through the continuous full connection layer, and outputting the final fake or real binary result.

8. The high-precision point cloud completion method based on deep learning according to claim 1, wherein the training method of the point cloud completion model comprises:
a loss function comprising two parts: a generated loss and an adversarial loss;
using a chamfer distance CD to calculate the average shortest point distance between the generated point cloud and the real point cloud on the ground, in which the calculation formula is as follows:
$${d}_{CD} ( {S}_{1} , {S}_{2} ) = {d}_{CD} ( {S}_{1} \to {S}_{2} ) + {d}_{CD} ( {S}_{2} \to {S}_{1} ) = \frac{1}{{S}_{1}} {\sum }_{x ∈ {S}_{1}} {min}_{y ∈ {S}_{2}} {‖ x - y ‖}_{2}^{2} + \frac{1}{{S}_{2}} {\sum }_{x ∈ {S}_{2}} {min}_{y ∈ {S}_{1}} {‖ y - x ‖}_{2}^{2}$$
where x and y represent a point in the generated point cloud or the real point cloud; P*P represents the distance; CD calculates the average nearest square distance between the generated point cloud S₁ and the real point cloud S₂, the final generated results are three generated point clouds P₁, P₂, P₃ of different scales, and the generated loss also consists of three parts, that is, d_{CD}_{₁}, d_{CD}_{₂}, d_{CD3}, which correspond to the CD values of the three generated point clouds of different scales, respectively, in which α represents the sum weight in the generated loss;
the generated loss L_{com} has the following expression:
L_{com}=d_{CD}_{₁}(P₁,P_{1gt})+αd_{CD}_{₂}(P₂,P_{2gt})+2αd_{CD}_{₃}(P₃,P_{3gt})
where P_{1gt}, P_{2gt}, P_{3gt} are the real point clouds corresponding to the three generated point clouds of different scales, respectively;
the adversarial loss refers to the adversarial network GAN, and the adversarial loss L_{adv} is as follows:
$${L}_{adv} = {\sum }_{1 \leq i \leq S} {log}_{10} ( G ( {y}_{i} ) ) + {\sum }_{1 \leq j \leq S} {log}_{10} ( 1 - G ( E ( D ( {x}_{i} ) ) ) )$$
where yᵢ and xᵢ belong to an original incomplete point cloud and a real point cloud, respectively, S represents the data set size; E, D, G represent the multi-resolution encoder, the pyramid decoder and the attention discriminator, respectively;
the total loss function L consists of the generated loss and the adversarial loss:
L=βL_{com}+λL_{adv}
β and λ are the weights of the generated loss L_{com} and the adversarial loss L_{adv}, respectively, satisfying the following condition: β+λ=1; the chamfer distance CD is also used as an evaluation index to test the completion performance.

9. A high-precision point cloud completion device based on deep learning, comprising a processor and a storage medium;
wherein the storage medium is configured to store instructions;
the processor is configured to operate according to the instructions to perform the steps of the method according to claim 1.

10. A storage medium on which a computer program is stored, wherein the computer program, when executed by a processor, implements the steps of the method according to claim 1.
